(19) United States
(12) Patent Application Publication
(10) Pub. No.: US 2017/0200237 A1
(43) Pub. Date: Jul. 13, 2017

(54) Manufacturing Accountability and Quality Assurance System and Method

(71) Applicant: GreaterThan Design, LLC, Verona, PA (US)

(72) Inventor: Mike Mehok, Austin, TX (US)

(73) Assignee: GreaterThan Design, LLC, Verona, PA (US)

(21) Appl. No.: 15/154,016

(22) Filed: May 13, 2016

Related U.S. Application Data
(60) Provisional application No. 62/277,080, filed on Jan. 11, 2016.

(51) Int. Cl. G06Q 50/04; G06Q 30/00; G06Q 20/12; G06Q 10/06

(52) U.S. Cl. CPC G06Q 50/04; G06Q 10/06316; G06Q 30/018; G06Q 20/12

(57) ABSTRACT

Disclosed is a system and method for conducting manufacturing transactions. In some embodiments, the present system includes a memory having stored thereon accountability based instructions, and a processor to execute the instructions resulting in a management service, wherein the management service may receive production requests corresponding to a plurality of consumers, wherein the management service may automatically determine the most cost effective and time efficient pathways to process the production requests while satisfying all quality requirements, wherein for each production request, the management service may receive quality control measures corresponding thereto, wherein all of the participants in the system complies with the quality control measures and one or more agents in the system can monitor and supervise the transactions.

### CROSS-REFERENCE TO RELATED APPLICATIONS

This application claims the benefit of U.S. Provisional Patent Application No. 62/277,080, filed Jan. 11, 2016, which is hereby incorporated by reference in its entirety.

### FIELD OF THE INVENTION

The present invention generally relates to manufacturing systems and methods. More particularly, the present invention is directed to a system and a method of increasing the quality control and accountability of manufactured goods while improving the efficiency of the same.

### BACKGROUND OF THE INVENTION

Existing systems and methods for automated manufacturing generally do not scale well compared to current mass production facilities. This is largely because there is a lack of quality control required for large production runs. This can be problematic for many small to medium businesses that run automated manufacturing, as these businesses often lack the resources needed for providing quality control and for providing assurances that many consumers demand. As a result, small to medium business are unable to manufacture as efficiently and as reliably as large companies and mass production facilities such as factories.

Various types of systems and methods for project management have been disclosed in the prior art. These include systems and methods that have been patented and published in patent application publications. For instance, some systems and methods disclose a marketplace environment for facilitating 3D printing services, wherein the marketplace environment facilitates transactions among consumers, manufacturers, and designers by providing a communication platform. Other systems and methods allow consumers to upload information, via a computing device, for producing printable objects at a remote location.

The systems and methods disclosed in the prior art have several known drawbacks, however. These systems and methods are limited in that they lack efficiency, and that they do not comprise agents for moderating communication among all parties (e.g., consumers, manufacturers, designers, etc.) throughout the duration of a project to maintain accountability and increase quality assurance while guaranteeing transactions. In this regard, the invention described herein addresses this problem.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments include, for example, devices, systems, and methods of providing manufacturing accountability and quality assurance. In one embodiment, the system comprises manufacturing apparatuses in a network. Additionally, the system comprises various participants and agents that provide quality control and accountability, wherein each of the participants and agents comprises a computer system for communicating with each other within the network, and wherein the participants conduct transactions for processing production requests and manufacturing goods and the agents manage and oversea the transactions.

Some embodiments of the system include a computing system including a memory having stored thereon accountability based instructions, and a processor to execute the instructions, causing the processor to receive and process data corresponding to production requests associated with a plurality of consumers, wherein the processor is to facilitate transactions for each of the production requests from beginning to completion.

In some embodiments, in facilitating transactions for each of the production requests, the processor is further configured to rank entities (i.e., one or more of the participants) involved in the production requests based on their capabilities and ratings of past transactions. Additionally, the processor can identify preferred supply and/or production chain relationships among the participants.

In some embodiments, in facilitating transactions for each of the production requests, the processor is further configured to delegate projects, for example, by unbundling and bundling large production requests among or from different entities to increase efficiency and quality control.

In some embodiments, in facilitating transactions for each of the production requests, the processor is further configured to hold or transfer funds for transactions associated with a plurality of consumers, for example, in escrow to guarantee the transactions.

In some embodiments, the processor is to automatically determine the most efficient and/or effective route to execute production requests based on one or more pathway factors, wherein the factors comprise, without limitation, the participants' locations, scheduling/availability, the participants' capabilities, the participants' rankings, and market fluctuations, among others. In this regard, the processor can recommend different pathways to conduct transactions for each of the production requests.

The present system can be configured for use in automated manufacturing for small and medium sized businesses, but it is also suitable for use by large companies and mass production facilities. In this way, the present system is configured to allow various types of entities to purchase products and/or product design services at any scale while expending reasonable costs.

In the light of the foregoing, these and other objectives are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a high-level block diagram of the present system.

FIG. 2 is an exemplary schematic diagram of the present system.

FIG. 3 shows a detailed block diagram of an exemplary database.

FIG. 4 shows an exemplary work flowchart of the present method.

FIG. 5 shows another exemplary work flowchart of the present method.

### DETAILED DESCRIPTION OF THE INVENTION

The present invention is directed towards a system and a method of increasing the quality control and accountability of manufactured goods. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” unless specified otherwise or clear from context to be directed to a singular form.

As used herein, the term “participant” means any registered individual, organization, or business entity that applies inputs to, or receives outputs from the present system, for reasons other than to directly maintain the system, unless the context clearly suggests otherwise. In one embodiment, the participants include producers, consumers, designers/scanners, customer service, and resourcers. As used herein, the term “agent” means moderators, inspectors, and any registered individual, organization, or business entity who directly maintains the system or whose primary task is to protect the participants within the system, unless the context clearly suggests otherwise. It is noted that each of the participants and the agents can comprise an entity, individuals, persons, or any combination thereof.

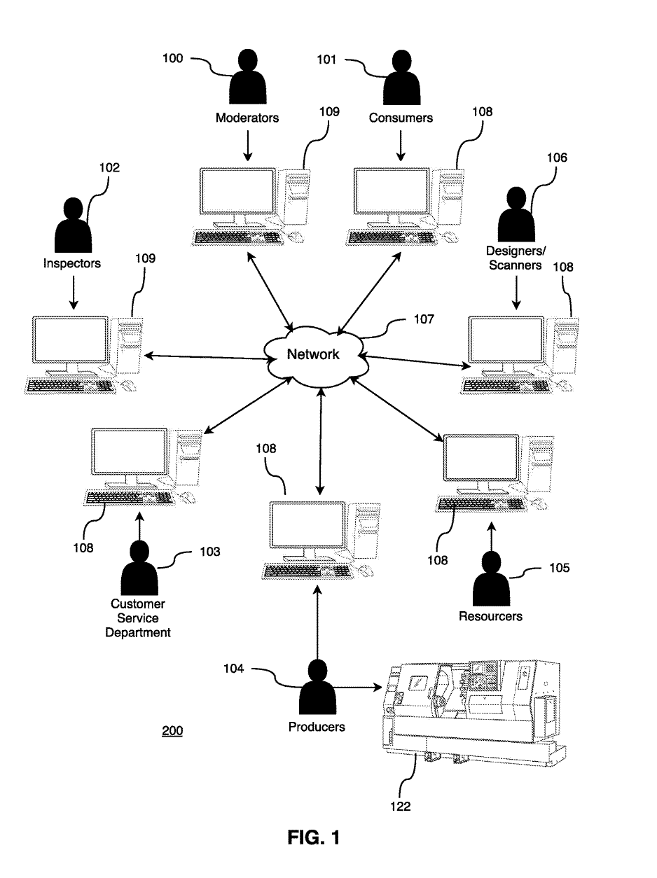

Some demonstrative embodiments are described herein in the context of manufacturing goods (i.e., requesting for production of goods and processing the requests). Referring now to FIGS. 1 through 3, there are shown exemplary block diagrams of the present system in accordance with some demonstrative embodiments.

In some embodiments, the system 200 includes one or more participants and one or more agents in a network 107, wherein the participants comprise a consumer 101, a customer service 103, a producer 104, a resourcer 105, and a designer/scanner 106; further wherein the agents comprise an inspector 102 and a moderator 100.

The consumers 101 can be a first-order consumer (e.g., a retail customer or client) or a second-order consumer (e.g., a producer 104 that needs intermediate parts from other participants within the present system in order to complete their order of a larger product). The consumer 101 may provide a request for goods to be produced, for example, by providing a digital representation of the goods, or directly use or modify a request designed by others and made available to him or her.

The designers/scanners 105 receive the production request from the consumer 101 to create and/or modify digital representations (e.g., in a standardized, electronic format) to be used in transaction requests to create the goods.

The producers 104 produce manufactured goods (i.e., the end product) to be delivered to the consumer 101. The producers 104 may utilize manufacturing devices 122 such as CNC machines, 3D printers, or other devices to produce prototypes, sub-assemblies, and/or finished products as required in the request. The producers 104 must meet quality control measures implemented by the present system and provide the first sign-off of a successful dispatch of end products to their final destination. The producers 104 can receive materials for manufacturing from the resourcers 105, wherein the resourcers 105 can provide new and/or recycled materials. The resourcers 105 can conduct continuous sales, ongoing sales, seasonal sales, and/or a one-time sale based on the availability of new, recycled, or waste materials.

The inspectors 102 are entities that respond to questions and concerns submitted by the participants. Moreover, the inspectors 102 enforce policies within the system and can ban participants that do not comply with the requirements. Tasks that are accomplished by the inspectors 102 are two generally fold. First, the inspectors 102 interact directly with each of the participants in order to determine the status of each transaction for each production request. It is contemplated that inspectors 102 can perform off-site and on-site inspections in order to determine the status of each transaction.

In some embodiments, the inspectors 102 can also moderate and delegate projects (i.e., “unbundle” and “bundle” large requests) to various producers 104 and designers/scanners 106. In another embodiment, the inspectors 102 can also guarantee each transaction among the consumers 101, producers 104, and designers/scanners 106. For instance, the inspectors 102 can hold funds for each transaction in escrow.

Second, the inspectors 102 identify trends within the system to improve the transactions related to production requests. For example, the inspectors 102 can identify under-utilized services in order to recommend those services to become removed or obsolete. The inspectors 102 can also identify reoccurring problems to recommend or provide additional resources to resolve problems.

The inspectors 102 preferably comprise human entities such as degreed professionals, practitioners, and/or acknowledged subject matter experts for at least one of the role types of the participants. In other embodiments, however, it is contemplated that the inspectors 102 can also comprises a machine, application, process, or routine running on a machine comprising machine learning algorithm.

Finally, the moderators 100 within the system monitor reviews, feedback, and discussion provided by various participants. More specifically, the moderators 100 ensure that the content of reviews, feedback, and discussion stays useful and relevant for all of the participants. In this regard, the moderators can ban and/or limit individual contents that do not comply within guidelines of the system.

In some embodiments, the devices 108, 109 may be implemented using suitable hardware components and/or software components, for example, processors 110, 129, memory units 111, 113 having instructions 162, 143 stored thereon, and input/output (I/O) systems 112, 137, wherein the I/O system 112, 137 can comprise manufacturing apparatuses 122 such as CNC machines 123 and 3D printers 124. Additionally, the devices 108, 109 can further comprise storage units, controllers, communication units, operating system, applications, or the like.

Each of the foregoing participants and agents operates a computer system 108, 109, respectively, for example, a PC, a laptop computer, a PDA device, and/or a terminal, that allow one or more participants and agents to analyze and/or perform one or more operations or transactions of one or more production requests; and to automatically perform one or more accountability based operations corresponding to the transactions as described herein.

Each of the computer systems 108, 109 is configured to establish communication with each other so as to allow the participants and/or agents to transmit information relating to various manufacturing requests and other transactions related thereto. In this regard, all communications are transmitted through the present system 200 so as to consolidate and record all information, thereby increasing accountability. Additionally, it is contemplated that each of the computer systems 108, 109 is configured to communicate with third party computer systems.

The system 200 further comprises one or more servers 138 and databases 116, wherein the servers 138 comprise computing systems including a processor 139 and a memory unit 140 having instructions 141 stored thereon. It is noted that the servers 138 can further comprise other components such as I/O systems, storage units, controllers, communication units, operation system, and applications, depending upon embodiment.

In some embodiments, the processor 139 is configured to execute the instructions 141, resulting in a management service 114 capable of providing the participants and the agents one or more management and accountability services and/or capabilities as described in detail below.

In some embodiments, the system 200 includes an interface 125 to interface among the participants, agents, and one or more elements of the present system, for example, the management service 114, and the database 115, among others. The interface 125 may be implemented as a part of the management service 114 and/or as part of any suitable system or module.

In some embodiments, the interface 125 may be associated with and/or included as part of the participant and/or agent systems 108, 109. In one example, the interface 125 may be implemented, for example, as middleware, as part of any suitable application, and/or as part of a server. The interface 125 may be implemented using any suitable hardware components and/or software components, for example, processors, controllers, memory units, storage units, input units, output units, communication units, operating systems, and applications. In some embodiments, the interface 125 may include, or may be part of a web-based application, a website, a webpage, a standalone application, a plug-in, a rich content component, or the like.

In some embodiments, the interface 125 is configured to allow the participants and/or agents to enter commands; to input and receive production requests corresponding to the consumers 101; to process production requests; to transact production requests; to make design changes; to transmit messages, for example, via direct messaging or message boards or forums; to update schedules and make status updates; to analyze and generate reports about production requests; to analyze any market information such as prices, trends, and the like; to monitor transactions; to determine pathways; and/or to otherwise control and/or analyze production requests as described herein.

The interface 125 further comprises a gallery 127 of previously submitted production requests, if any, wherein the previously submitted requests can be used as a reference to gather information about related production requests and/or similar production requests to increase the speed of transactions. In this regard, the consumers 101 and/or other participants can access the previously submitted requests to review completed transactions.

Additionally, the gallery 127 is configured to enable designers/scanners 106 to display examples of their work related to the requests to increase exposure to the consumers 101 and to increase their popularity. Similarly, the producers 104 can also display examples of their work related to the requests (e.g., produced goods). It is contemplated that the galleries 127 can be made public or private, such that only selected individuals can access the gallery 127, for example, via invites, account status, and the like.

The interface 125 comprises a participant user interface 126 and an agent user interface 128, wherein the agent user interface 126 is dependent upon an agent's area of expertise 154 and skill level 155, or the agent's role 152. The expertise 154 and skill level 155 corresponding to the agent are associated with the agent's account information 136, wherein the agent's account information 136 includes other agent-specific information corresponding with the agent.

It is contemplated that the agent can input his or her expertise 154 and/or skill level 155 via the agent system 109 manually. Alternatively, the agent's expertise 154 and/or skill level 155 can be automatically obtained from a third party source, for example, a credentialing entity. The agent is given a role based on the agent's expertise 154 and skill level 155. The role 152 of any given agent within the present system 200 does not change except through testing and promotion, which can be implemented via the present system 200 periodically. Therefore, the agent user interface 126 is monolithic.

In one embodiment, the inspectors 102 can use the agent user interface 128 in order to access raw data on transactions, wherein the data can be stored in a database 116. For example, the inspectors 102 can view the original production or transaction request 130, photos/documents 131, status reports 134, and other types of data. These data can be used to identify the trends within the system. Additionally, the inspectors 102 can communicate with other inspectors 102 via, for example, a messaging tool 161.

In contrast, the participants may switch among a number of roles 153 (i.e., consumers, designers/scanners, resourcers, producers, customer service, inspectors) as they interact with the system 200. In this regard, the participants can manually select the role 153 which they partake via the participant system 108. Alternatively, the management service 114 can automatically detect the participant's role 153 based on the participant's transactions. Accordingly, the participant user interface 126 is customizable within the limits of the roles 153 they use.

Additionally, the participant user interface 126 provides a customer service interface from which a consumer can obtain assistance from, for example, a customer service department 103, (e.g., troubleshoot or problem resolution) and receive messages from other participants (i.e., another consumer, designers/scanners, resourcers, producers, customer service, inspectors, etc.) or agents via the messaging tool 161. For instance, the consumer 101 may receive notifications to provide additional information or receive recommendations to utilize specific designers and/or scanners 106 to improve and/or normalize the request. In another example, the consumer 101 can directly communicate with other participants on a message board. The message board can be monitored by one or more agents (e.g., moderator 100) so that the agent can ban and/or limit individual contents that do not comply within guidelines of the system.

In one embodiment, the participants can use the participant user interface 126 in order to report status updates, wherein the status updates are automatically generated into status reports 134. For example, the resourcers 105 can update inventory information 133 via the participant user interface 126.

In some embodiments, the participant user interface 126 for certain participants include a linking tool 142 to link certain participants together, for example, to create preferred supply and/or production chain relationships. For example, the consumers 101 can link one or more of the resourcers 105 to a specific producer 104. This feature may be particularly advantageous for products that require numerous sub-parts or for products that are complicated to assemble.

The participants may also indirectly interact with one or more elements of the present system 200, for example, an entity such as a bank 121 for holding escrow funds, via communication between the agent system 109 and the participant system 108. It is contemplated that the escrow funds and any information relating to the escrow funds (e.g., account information, escrow amount, etc.) are stored in a database 115.

Without limitation, the management service 114 is configured to provide quality control service 119 for ensuring that the transactions meet the quality control measures 151 as defined by the system, participant rankings 146 for ranking each of the participants, delegation service 160 for unbundling and bundling multiple production requests, and pathways service 156 for increasing the efficiency of processing the production requests.

In some embodiments, the quality control measures 151 are defined by third parties (e.g., industry standards) and implemented in the present system. Additionally, the quality control measures 151 can be defined by the agents of the present system. The quality control service 119 utilizes the quality control measures 151 to determine whether certain transactions and/or the produced goods comprise a desired level of quality or meet the desired threshold of quality requirements, wherein the desired level or threshold are predefined in the quality control measures 151.

The participant rankings service 146 can utilize the data obtained from the transactions in order to rate or rank each of the participants. For example, the participant rankings service 146 can rank participants based on their capabilities (e.g., equipment/resources available, experience level, etc.) and ranking information 149 from previous transactions.

The delegation service 160 enables the inspectors 102 to moderate and delegate projects, or unbundle/bundle large production requests or requests that meet a predetermined set of conditions. For instance, the delegation service 160 can automatically bundle the production requests for similar goods or goods that require similar materials or parts. In another example, the delegation service 160 can unbundle a production request that requires multiple sub-parts so as to delegate the production of each sub-part to different producers 104.

The pathways service 156 enables the management service 114 to calculate the most efficient way to process production requests or to calculate a pathway that meets predefined criterion. The pathways service 156 is configured to determine, for example, the most cost effective and/or time efficient way to produce the manufactured goods at a desired level of quality, by considering pathway factors 150 such as: a physical distance between the participants associated with a production request; scheduling; availability and/or capabilities of participants; reputation and reliability of participants to make and/or handle requests; market fluctuations affecting the availability of resource materials, etc.

In this regard, the pathways service 156 can recommend a plurality of pathways and enable a participant to choose a preferred pathway or automatically select a pathway that has the highest efficiency value. The selected pathway and any information relating to the pathways 150 is then stored in the database 116. In some embodiments, the pathways can be evaluated based on its success or failure. More specifically, a pathway receives a positive evaluation upon a successful completion of a production request, wherein the production is successful, for example, if the manufactured goods meet all quality requirements, deadlines, and budget. Pathways that receive positive evaluations can be reused for future production requests. Conversely, a pathway receives a negative evaluation upon an unsuccessful completion of a production request, wherein the production is unsuccessful, for example, if the manufactured goods do not meet all quality requirements and exceed deadlines and budget. Pathways that receive negative evaluations are not reused for future production requests.

In some embodiments, consumers 101 may or may not be able to view and/or map their preferred pathways within the system via the participant user interface 126, depending upon embodiment.

The database 116 communicates with one or more elements of the system 200 to store information therein. For instance, some embodiments of the database 116 comprise participant account information 135, agent account information 136, wherein each of the participant account information 136 and the agent account information 136 comprises information relating to each of the respective participants and the agents. In this regard, the agent account information 136 comprises expertise 154 and skill level 155 information associated with the agent corresponding to the account.

The database 116 further comprises information relating to production requests, for example, consumer requests 130, inventory information 133, participant rankings information 149, status reports 134, and pathway information/factors 150, quality control measures 151, wherein the consumer requests 130 comprise information relating to each of the production requests and any photographs/documents 131 relating thereto.

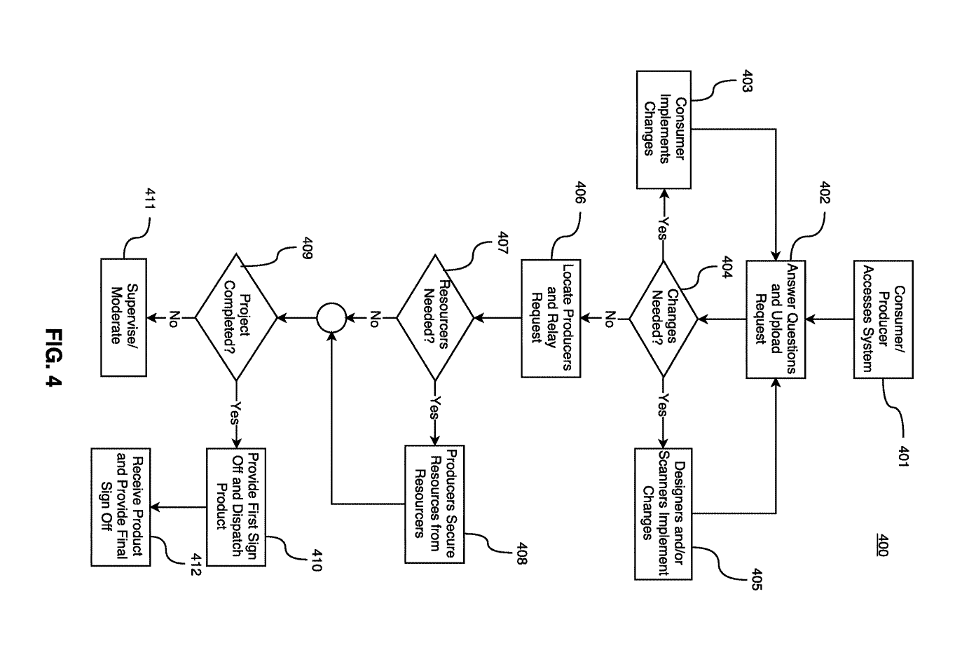

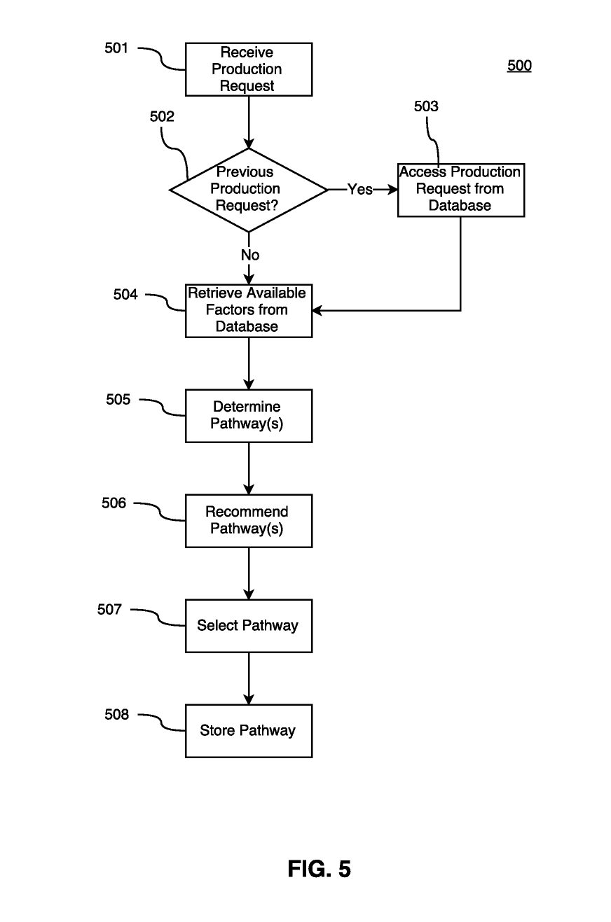

Reference is also made to FIGS. 4 and 5, which schematically illustrate exemplary methods of the present invention. In some embodiments, one or more operations of FIGS. 4 and 5 may be performed by one or more elements of the system 200.

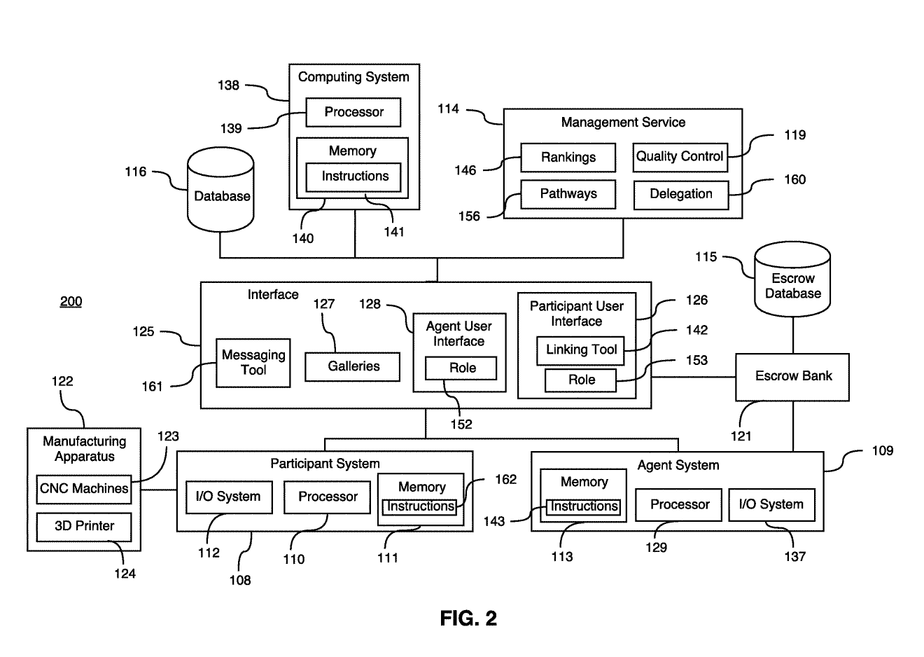

As indicated in block 401, the present method 400 generally begins with a consumer 101 (FIG. 1) (i.e., a first order) accessing the present system, for example, on a website via the participant system 108, in order to upload a production request and to provide any information relating thereto 402 via the participant system 108 (FIG. 2), wherein the consumer 101 (FIG. 1) provides an input of physical objects for manufacture or production. Non-limiting examples of objects for manufacture include prototypes, sub-assemblies, and/or finished products.

The objects for manufacture are preferably scanned via a scanner or a similar device to create at least one digital representation of the same. It is noted that the exact configuration or type of the scanner is not of particular importance, as the present invention primarily focuses on a system and a method of increasing the quality control and accountability of manufactured goods. In another embodiment, the present method begins with a producer 104 (FIG. 1) (i.e., a second order), in which the producer 104 (FIG. 1) requests intermediate parts to complete an order for building another product.

As indicated in block 404, the consumer 101 (FIG. 1) and/or the designer/scanner 106 (FIG. 1) can determine whether any changes to the request are needed. For instance, the designer/scanner 106 (FIG. 1) can provide design inputs for the requested objects based on the needs of the consumer and the designer/scanner's expertise. Thus, the present application provides a platform on which the designer/scanner 106 (FIG. 1) and consumers 101 (FIG. 1) can directly and/or indirectly communicate. Alternatively, the management service 114 is configured to automatically detect any errors and provide notifications. For example, the management service 114 can compare the uploaded production request with similar production requests previously submitted and/or archived in order to identify errors and/or any missing information.

If any changes are needed, the consumers 101 (FIG. 1) can implement changes 403; or the designers/scanners 106 (FIG. 1) can implement changes 405 via the participant systems 108 (FIG. 2). If no more changes are needed, the management service 114 locates producers 104 (FIG. 1) and relays the request to the producers 104 (FIG. 1) for production, as indicated in block 406.

The producers 104 (FIG. 1) input digital representation of physical objects from a consumer's request and output physical objects (e.g., prototypes, sub-assemblies, and/or finished products). Each of the producers 104 (FIG. 1) or producing entities is registered into the present system to provide manufacturing services using manufacturing devices 122 (FIG. 1) such as CNC machines, 3D printers, and the like. The producers 104 (FIG. 1) may work alone or with other producers to output physical objects, depending upon embodiment. More specifically, two or more producers 104 (FIG. 1) may work together upon a consumer's request.

In operation, the producers 104 (FIG. 1) receive instructions and quality control measures implemented by the system via the application. As indicated in block 407, the method further includes determining whether resourcers 105 (FIG. 1) are needed to obtain specific materials. If resourcers 105 are needed, the producers 104 (FIG. 1) can locate resourcers 105 (FIG. 1) to secure resources for the production request 408. In some embodiments, the producers 104 (FIG. 1) may be automatically linked to specific resources 105 (FIG. 1) via the linking tool 142 (FIG. 2), which is configured to establish preferred supply and/or production chain relationship.

As indicated in block 409, the method includes determining whether the project has been completed. If the project is not completed, the agents continuously supervises and/or moderates the production request 411. In this way, the consumer 101 (FIG. 1) and other participants can access status updates relating to the request.

If the project is completed 410, the producers 104 (FIG. 1) may provide the first or initial sign-off of a successful dispatch of end products to their final destination, via the participant user interface 126 (FIG. 2) (i.e., the consumer 101 (FIG. 1)). Upon receiving the end products, the consumer 101 (FIG. 1) can give the final approval via the participant user interface 126 (FIG. 2) 412.

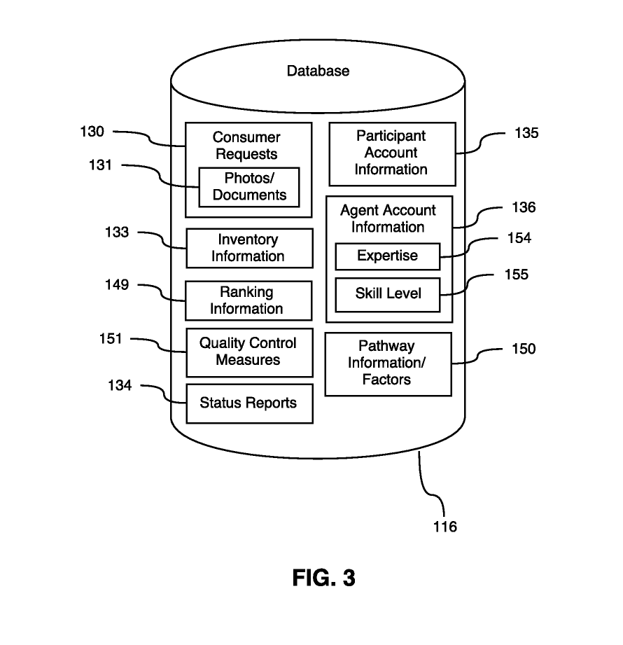

In some embodiments, the present invention further comprises a method 500 for increasing the efficiency of manufacturing. As indicated in block 501, the method includes receiving a production request from a consumer. The pathways service 156 (FIG. 2) of the management service 114 (FIG. 2) determines whether the received production request 502 is a previously submitted production request. If the production request 502 is an existing production request, the management service 114 (FIG. 2) retrieves the production request from the database 116 (FIG. 3) 503.

As indicated in block 504, the pathways service 156 (FIG. 2) is configured to retrieve available pathway factors 150 (FIG. 3) from the database 116 (FIG. 3), wherein the factors comprise the participant's locations, scheduling/availability, the participant's capabilities the participant's rankings, and market fluctuations, among others. As indicated in block 505, the pathways service 156 (FIG. 2) is configured to determine one or more pathways that are the most time efficient and cost effective or that meets predefined criterion.

As indicated in block 506, the pathways service 156 (FIG. 2) can recommend one or more pathways via the interface 125 (FIG. 2). In some embodiments, the pathways service 156 (FIG. 2) can automatically select the best pathway or allow a participant to select the pathway manually 507.

As indicated in block 508, the pathways service 156 (FIG. 2) is configured to store the pathway selected in the database 116 (FIG. 3). In some embodiments, the pathways service 156 (FIG. 2) is configured to store pathways that were not selected. Additionally, the pathways service 156 is configured to determine whether the selected pathway resulted in a successful completion of a production request or an unsuccessful completion of a production request. In this regard, pathways that result in successful completion of production requests can be reused or used as a model for future pathways that are produced, for example, via machine learning.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for conducting manufacturing transactions, comprising:
a memory unit having stored thereon accountability based instructions; and
a processor to execute said accountability based instructions resulting in a management service, wherein said management service is to:
receive production requests for manufacturing goods corresponding to a plurality of consumers;
determine at least one recommended pathway for processing said production requests based on pathway factors received from a database, wherein in determining said at least one recommended pathway is to identify a pathway that meets a predetermined criterion, said predetermined criterion relating to said production requests;
relay said production requests to producers for production via manufacturing apparatuses; and
supervise and moderate transactions related to said production requests to ensure said transactions comply with quality control measures in said database.

2. The system of claim 1, wherein said management service comprises a delegation service for delegating said production requests, and wherein in delegating said production requests, said production requests are unbundled and bundled.

3. The system of claim 1, wherein said management service is further configured to implement changes received from said plurality of consumers and designers/scanners to said production requests.

4. The system of claim 3, further comprising an interface for interfacing with said management service, wherein said interface comprising a gallery and a messaging tool, wherein said gallery is configured to display work related to said production requests, wherein said work is associated with said producers or said designers/scanners, and wherein said gallery is public or private.

5. The system of claim 4, wherein said interface comprises a participant user interface and an agent user interface, and wherein said agent user interface is dependent upon an agent's role.

6. The system of claim 1, wherein said management service is further configured to hold funds for said transactions in escrow in order to guarantee production requests.

7. The system of claim 1, wherein said management service is further configured to identify preferred supply and/or production chain relationships.

8. A system for conducting manufacturing transactions, comprising:
at least one participant system connected to a network, wherein each of said at least one participant system is operated by a participant, wherein said participant comprises a plurality of consumers and producers;
at least one manufacturing apparatus in communication with said at least one participant system;
at least one agent system connected to said network, wherein each of said at least one agent system is operated by an agent;
a server connected to said network, said server comprising a memory unit having stored thereon accountability based instructions, and a processor to execute said accountability based instructions to result in a management service, wherein said management service is configured to:
receive production requests for manufacturing goods corresponding to said plurality of consumers;
determine at least one recommended pathway for processing said production requests based on pathway factors received from a database, wherein in determining said at least one recommended pathway is to identify a pathway that meets a predetermined criterion, said predetermined criterion relating to said production requests;
relay said production requests to said producers for production via manufacturing apparatuses; and
supervise and moderate transactions related to said production requests to ensure said transactions comply with quality control measures in said database.

9. The system of claim 8, wherein said management service comprises a delegation service for delegating said production requests, and wherein in delegating said production requests, said production requests are unbundled and bundled.

10. The system of claim 8, wherein said management service is further configured to implement changes received from said plurality of consumers and designers/scanners to said production requests.

11. The system of claim 8, wherein said at least one participant system is associated with a participant user interface, wherein said at least one agent system is associated with an agent user interface, and wherein said agent user interface is dependent upon an agent's role.

12. The system of claim 11, wherein each of said participant user interface and said agent interface comprise a gallery and a messaging tool, wherein said gallery is configured to display work related to said production requests, wherein said work is associated with said producers or said designers/scanners, and wherein said gallery is public or private.

13. The system of claim 8, wherein said management service is further configured to hold funds for said transactions in escrow in order to guarantee production requests.

14. The system of claim 8, wherein said management service is further configured to identify preferred supply and/or production chain relationships.

15. The system of claim 8, wherein said management service comprises a ranking service for ranking said participant based on capabilities and rankings from previous transactions.

16. The system of claim 8, wherein said at least one manufacturing apparatus comprises CNC machines and 3D printers.
